(19) United States
(12) Patent Application Publication
(10) Pub. No.: US 2021/0239081 A1
(43) Pub. Date: Aug. 5, 2021

(54) FUEL INJECTION VALVE

(71) Applicant: Hitachi Automotive Systems, Ltd., Hitachinaka-shi, Ibaraki (JP)

(72) Inventors: Takuya WATAI, Hitachinaka-shi (JP); Takao MIYAKE, Hitachinaka-shi (JP); Masashi SUGAYA, Hitachinaka-shi (JP); Yasuo NAMAIZAWA, Hitachinaka-shi (JP)

(73) Assignee: Hitachi Automotive Systems, Ltd., Hitachinaka-shi, Ibaraki (JP)

(21) Appl. No.: 15/734,482

(22) PCT Filed: Aug. 8, 2019
(86) PCT No.: PCT/JP2019/031318

§ 371 Date: Dec. 2, 2020

(30) Foreign Application Priority Data
Aug. 24, 2018 (JP) 2018-157588

(51) Int. Cl. F02M 61/18; F02M 61/04; F02M 51/06; F02M 61/20

(52) U.S. Cl. CPC F02M 61/188; F02M 61/20; F02M 51/061; F02M 61/04

(57) ABSTRACT

Provided is a fuel injection valve capable of improving durability as compared with the conventional case and making the amount of fuel injected uniform as compared with the conventional case. Further, the present invention provides a fuel injection valve capable of injecting fuel with a high fuel pressure as compared with the conventional case and improving the reliability of the product as compared with the conventional case. For this reason, the configuration has a shape relationship in which φB>φC>φD>φE>φF is satisfied where φB represents a hole diameter of a valve body insertion hole 31 consisting of the through hole formed in the central axis of a movable core 30, φC represents an outer diameter of an intermediate portion 22, of a valve body 20, that slides on a valve body insertion hole (through hole) 31, φD represents a diameter of an inner peripheral face 121 of a front end member 12 having an injection hole 11 that slides on a front end side (downstream side) spherical portion 230 of the valve body 20, φE represents an outermost diameter (sphere diameter) of a front end side (downstream side) spherical portion 230 of the valve body 20, and φF represents an outer diameter of a neck 223, the smallest diameter portion, which is located toward the rear end (upstream) relative to the front end side (downstream side) spherical portion 230 of the valve body 20 and located at the intermediate portion 22 of the valve body 20, and a side face of the movable core 30 and the inner peripheral face of the nozzle body 10 are not in contact with each other.

### TECHNICAL FIELD

The present disclosure relates to a fuel injection valve.

### BACKGROUND ART

In the related art, an invention related to a common rail injector for injecting fuel in a common rail injection system of an internal combustion engine has been known (see Patent Literature 1 below). The common rail injector described in Patent Literature 1 is provided with an injector casing including a fuel supply unit. The fuel supply unit is connected to a central fuel high-pressure accumulator provided outside the injector casing and a pressure chamber provided inside the injector casing. From this pressure chamber, high pressure loaded fuel is injected in relation to the position of the control valve.

When the pressure in the pressure chamber is larger than the pressure in the control chamber connected to the fuel supply unit via the supply throttle, the control valve works to allow the nozzle needle to lift from the seat in the longitudinal hole of the injector. This nozzle needle is capable of reciprocating in the axial direction against the preload force of the nozzle spring received in the nozzle spring chamber.

In this type of common rail injector, the control chamber has a cylindrical chamber. In the chamber of the control chamber, the control pin formed at the end of the nozzle needle opposite to the combustion chamber can be shifted by a sealing action. The nozzle spring chamber is disposed outside the control chamber in the region of the end of the nozzle needle opposite to the combustion chamber (see the same document, claim 1 and the like).

In the injector according to this conventional invention, the control chamber and the nozzle spring chamber at the end of the nozzle needle opposite to the combustion chamber can be combined without the volume of the control chamber being affected by the structural space of the nozzle spring. Therefore, it is possible to incorporate a nozzle spring with a high spring strength that allows for good closure of the nozzle needle. Thereby, the injection time and the injection timing can be accurately determined (see the same document, paragraph 0006, etc.).

### CITATION LIST

### Patent Literature

PTL 1: JP 2003-506620 A

### SUMMARY OF INVENTION

### Technical Problem

As in the injector according to the conventional invention, the injector (fuel injection valve) used in the internal combustion engine is required to reduce particulate matter in the exhaust gas of internal combustion engines, and the number of fuel injections per cycle tends to increase. Therefore, it is required to improve the durability of the fuel injection valve and make the amount of fuel injected uniform.

This disclosure has been made in view of the above circumstances. An object of the disclosure is to provide a fuel injection valve capable of improving the durability as compared with the conventional case, and making the amount of fuel injected uniform as compared with the conventional case.

### Solution to Problem

According to an aspect of the present disclosure, a fuel injection valve includes a nozzle body having an injection hole, a valve body having a front end that opens and closes the injection hole, a movable core that has a through hole in which the valve body is slidably inserted, and that is engaged with a rear end of the valve body to move together with the valve body, and a fixed core that attracts the movable core by a magnetic attraction force, wherein the front end of the valve body has a spherical portion that slides on an inner peripheral face of the nozzle body, and an intermediate portion between the front end and the rear end of the valve body has an insertion portion that is inserted into the through hole to slide on the through hole, and a neck located downstream of the insertion portion and upstream of the spherical portion, and φB>φC>φD>φE>φF is satisfied where φB represents a hole diameter of the through hole formed in the movable core, φC represents an outer diameter of the insertion portion at the intermediate portion, of the valve body, that slides on the through hole, φD represents a diameter of the inner peripheral face, of the nozzle body, that slides on the spherical portion of the valve body, φE represents an outermost diameter of the spherical portion of the valve body, and φF represents an outer diameter of the neck at the intermediate portion of the valve body, and a side face of the movable core and the inner peripheral face of the nozzle body are not in contact with each other.

### Advantageous Effects of Invention

According to the above aspect of the present disclosure, it is possible to provide a fuel injection valve capable of improving the durability as compared with the conventional case and making the amount of fuel injected uniform as compared with the conventional case.

Problems, configurations, and effects other than those described above will become apparent from the following description of embodiments.

### BRIEF DESCRIPTION OF DRAWINGS

FIG. 1 is a vertical sectional view of a fuel injection valve according to an embodiment of the present disclosure.

FIG. 2 is an enlarged perspective view of a rear end of a valve body of the fuel injection valve shown in FIG. 1.

FIG. 3 is an enlarged plan view of the rear end of the valve body of the fuel injection valve shown in FIG. 1.

FIG. 4 is an enlarged vertical sectional view of the vicinity of the rear end of the valve body of the fuel injection valve shown in FIG. 1.

FIG. 5 is an enlarged vertical sectional view of the vicinity of the front end of the valve body of the fuel injection valve shown in FIG. 1.

FIG. 6 is a schematic view of the valve body of the fuel injection valve and components near the valve body shown in FIG. 1.

### DESCRIPTION OF EMBODIMENTS

Hereinafter, embodiments of the fuel injection valve according to the present disclosure will be described with reference to the drawings.

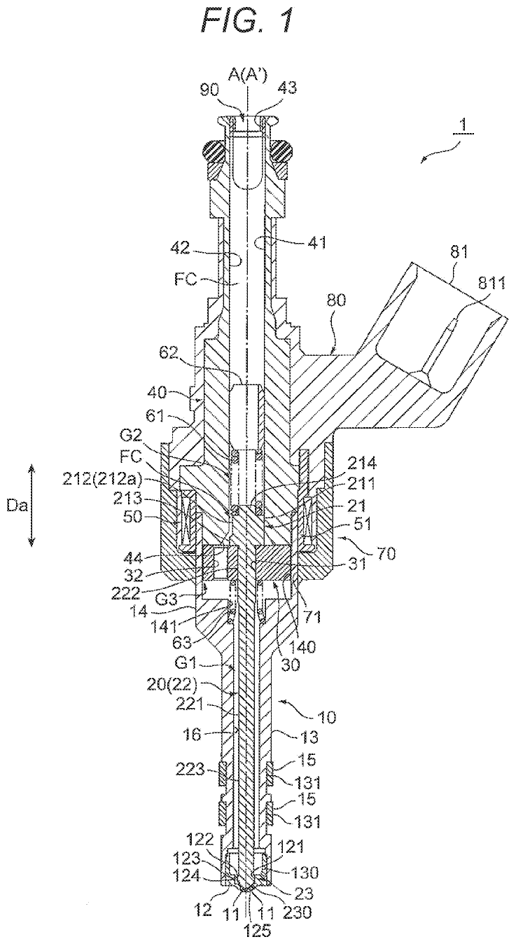

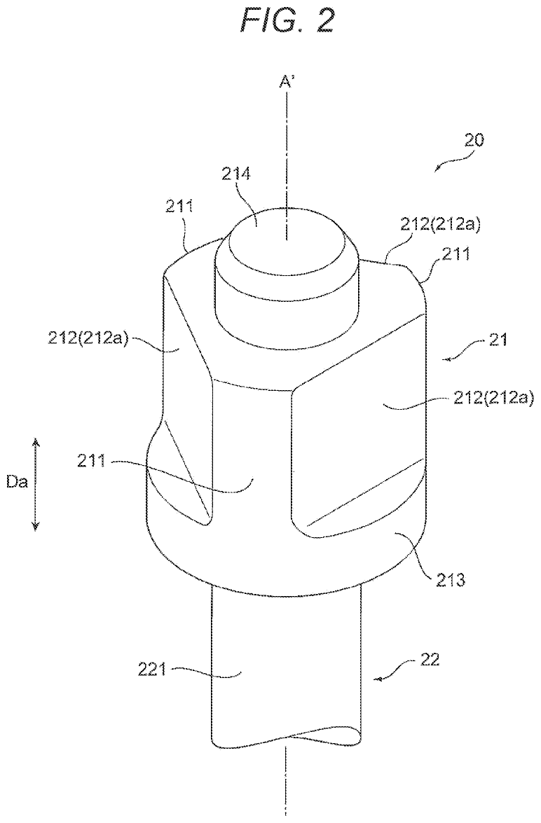

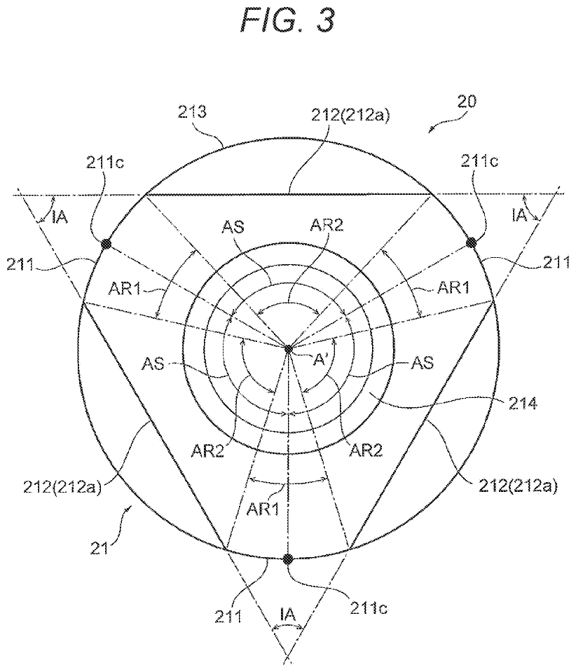

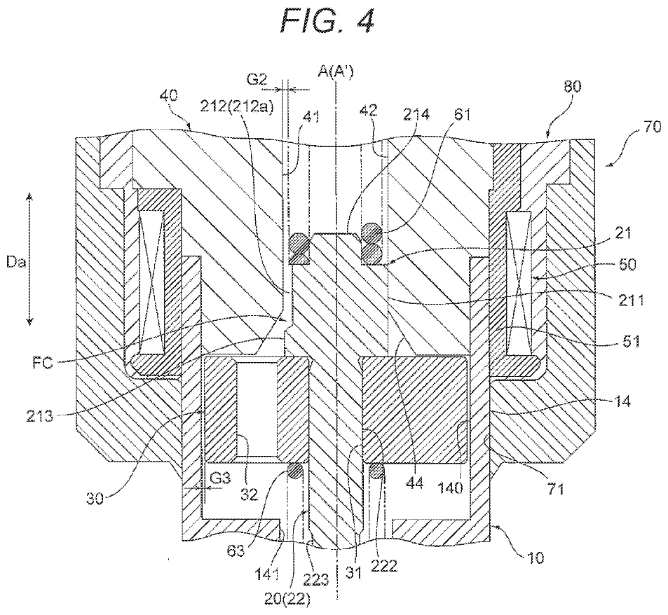

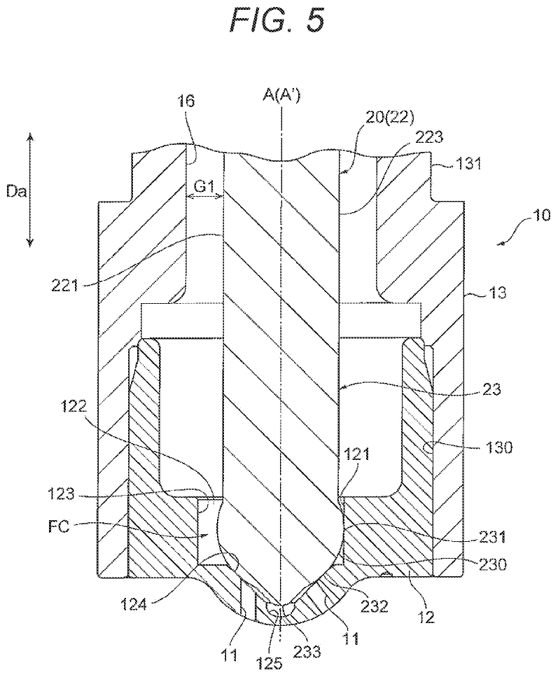

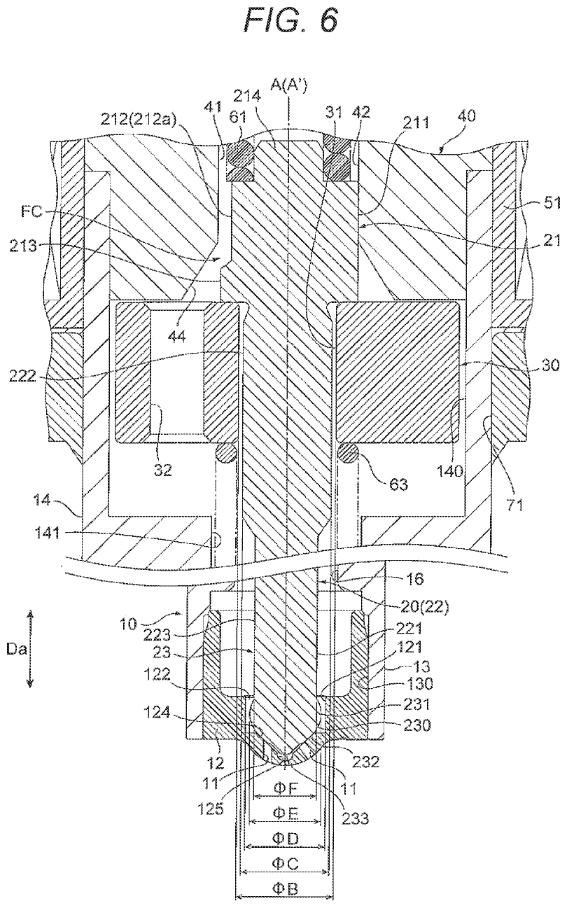

FIG. 1 is a vertical sectional view of a fuel injection valve 1 according to the embodiment of the present disclosure. FIG. 2 and FIG. 3 are an enlarged perspective view and an enlarged plan view of a rear end 21 of a valve body 20 of the fuel injection valve 1 shown in FIG. 1, respectively. FIG. 4 is an enlarged vertical sectional view of the vicinity of the rear end 21 of the valve body 20 of the fuel injection valve 1 shown in FIG. 1. FIG. 5 is an enlarged vertical sectional view of the vicinity of a front end 23 of the valve body 20 of the fuel injection valve 1 shown in FIG. 1. FIG. 6 is a schematic view of the valve body 20 of the fuel injection valve 1 and components near the valve body 20 shown in FIG. 1.

The fuel injection valve 1 of the present embodiment includes a tubular nozzle body 10, an injection hole 11 provided at the front end of the nozzle body 10 in an axial direction Da (hereinafter, simply referred to as the “axial direction Da”) along a central axis A, and the valve body 20 having the front end 23 extending in the axial direction Da to open and close the injection hole 11. Further, the fuel injection valve 1 includes a movable core 30 that is engaged with the rear end 21 of the valve body 20 to move in the axial direction Da together with the valve body 20, a tubular fixed core 40 that attracts this movable core 30 by a magnetic attraction force, and a coil 50 which causes this fixed core 40 to generate the magnetic attraction force. Here, the rear end 21 of the valve body 20 is an end (also referred to as a proximal end) opposite to the front end 23 of the valve body 20 in the axial direction Da.

Although the details will be described later, the fuel injection valve 1 of the present embodiment has the following configuration as the first feature. The configuration has a shape relationship in which φB>φC>φD>φE>φF is satisfied where φB represents a hole diameter of a valve body insertion hole 31 consisting of the through hole formed in the central axis of the movable core 30, φC represents an outer diameter of an intermediate portion 22, of the valve body 20, that slides on the valve body insertion hole (through hole) 31, φD represents a diameter of sliding with a front end member 12 having the injection hole 11 that slides on a front end side (downstream side) spherical portion 230 of the valve body 20, φE represents an outermost diameter (sphere diameter) of the front end side (downstream side) spherical portion 230 of the valve body 20, and φF represents an outer diameter of a neck 223, the smallest diameter portion, which is located toward the rear end (upstream) relative to the front end side (downstream side) spherical portion 230 of the valve body 20 and located at the intermediate portion 22 of the valve body 20, and a side face of the movable core 30 and the inner peripheral face of the nozzle body 10 are not in contact with each other. In other words, the front end 23 of the valve body 20 has the spherical portion 230 that slides on the inner peripheral face of the front end member 12 of the nozzle body 10, the intermediate portion 22 between the front end 23 and the rear end 21 of the valve body 20 has an insertion portion 222 that is inserted into the valve body insertion hole 31 consisting of the through hole formed in the movable core 30 and that slides on the valve body insertion hole (through hole) 31, and the neck 223 located downstream of the insertion portion 222 and upstream of the spherical portion 230, and the configuration has a shape relationship in which φB>φC>φD>φE>φF is satisfied where φB represents a hole diameter of the valve body insertion hole (through hole) 31 formed at the central axis of the movable core 30, φC represents an outer diameter of the insertion portion 222 at the intermediate portion 22, of the valve body 20, that slides on the valve body insertion hole (through hole) 31, φD represents a diameter of the inner peripheral face, of the front end member 12 of the nozzle body 10, that slides on the spherical portion 230 of the valve body 20, 9E represents an outermost diameter (sphere diameter) of the spherical portion 230 of the valve body 20, and φF represents an outer diameter of the neck 223 at the intermediate portion 22 of the valve body 20, and a side face of the movable core 30 and the inner peripheral face of the nozzle body 10 are not in contact with each other.

Similarly, although details will be described later, the fuel injection valve 1 of the present embodiment has the following configuration as a second feature. The valve body 20 is composed of one member from the rear end 21 to the front end 23. Further, the front end 23 of the valve body 20 has the spherical portion 230, and a front end side sliding portion 231 of the spherical portion 230 that slides on an inner peripheral face 121 of the front end member 12 of the nozzle body 10 and a seat portion 232, of the spherical portion 230, that contacts (is seated on) a seat face 124 of the front end member 12 of the nozzle body 10 are formed of the same spherical face.

Similarly, although details will be described later, the fuel injection valve 1 of the present embodiment has the following configuration as a third feature. The nozzle body 10 has the concave front end member 12 which has the injection hole 11 and receives the front end 23 of the valve body 20. The valve body 20 is composed of one member from the rear end 21 to the front end 23, and has a rear end side sliding portion 211 and a front end side sliding portion 231 at the rear end 21 and the front end 23, respectively. The valve body 20 is configured such that when the injection hole 11 is opened and closed, the rear end side sliding portion 211 of the rear end 21 contacts an inner peripheral face 41 of the fixed core 40 to slide in the axial direction Da, and the front end side sliding portion 231 of the front end 23 contacts the inner peripheral face 121 of a recess 122 of the front end member 12 to slide in the axial direction Da.

Hereinafter, each part of the fuel injection valve 1 of the present embodiment will be described in more detail.

As described above, the fuel injection valve 1 mainly includes the nozzle body 10, the valve body 20, the movable core 30, the fixed core 40, and the coil 50. Further, the fuel injection valve 1 includes, for example, a coil bobbin 51, a coil spring 61, an adjustment member 62, a small coil spring 63, a housing 70, a resin portion 80, and a filter 90. Further, the nozzle body 10 has the front end member 12.

The nozzle body 10 has a substantially cylindrical shape, for example, extending in the axial direction Da, and has the injection hole 11 at the tip thereof. The round bar-shaped or columnar valve body 20 extending in the axial direction Da is inserted inside the nozzle body 10. The nozzle body 10 has a small diameter portion 13 at the front end where the injection hole 11 is provided, and a large diameter portion 14 at the rear end opposite to the injection hole 11. The outer diameter of the large diameter portion 14 is larger than the outer diameter of the small diameter portion 13.

The small diameter portion 13 has a concave internal space 130 that opens to the front end side inside the front end, and the front end member 12 is inserted or press-fitted into the concave internal space 130. The front end member 12 has a concave shape, and is fixed to the small diameter portion 13 by, for example, the outer peripheral edge of the bottom face, that is, the front end face, being welded to the inner peripheral edge of the opening at the front end of the small diameter portion 13 over the entire circumference. The small diameter portion 13 has a groove 131 at the outer peripheral face of the front end (in the illustrated example, two upper and lower grooves 131), and a combustion gas sealing member 15 such as a resin chip seal is fitted in the groove 131.

The large diameter portion 14 has a bottomed cylindrical internal space 140 having an opening at the end (that is, the rear end) toward the fixed core 40, and the annular or cylindrical movable core 30 is housed (with a gap) in the internal space 140. Further, a cylindrical recess 141 is provided at the central portion of the bottom of the internal space 140 of the large diameter portion 14, and one end of the small coil spring 63 that urges the movable core 30 in a direction which it is away from the injection hole 11, that is, in the valve opening direction, is housed in the recess 141.

In the large diameter portion 14, the front end of the stepped cylindrical fixed core 40 is press-fitted inside the opening of the internal space 140, and (the large diameter portion 14 of) the nozzle body 10 and the fixed core 40 are joined by welding. As a result, the gap between the nozzle body 10 and the fixed core 40 is sealed, and the space inside the large diameter portion 14 is sealed. The cylindrical coil bobbin 51 and the coil 50 wound around the coil bobbin 51 are disposed at the outer periphery of the large diameter portion 14 of the nozzle body 10 and the front end of the fixed core 40, and the bottomed cylindrical housing 70 is fixed to the outer periphery thereof via the resin portion 80.

As shown in FIG. 1 to FIG. 4, the valve body 20 has, for example, a plurality of rear end side sliding portions 211, a plurality of flow path forming portions 212, and an annular or short columnar engaging portion 213 at the rear end 21 opposite to the front end 23 that opens and closes the injection hole 11. Further, the valve body 20 has, for example, the rear end side sliding portion 211 and the front end side sliding portion 231 at the rear end 21 and the front end 23, respectively, as shown in FIG. 1 to FIG. 5. Further, the valve body 20 has a gap G1 between an outer peripheral face 221 of the intermediate portion 22 between the rear end 21 and the front end 23 and an inner peripheral face 16 of the nozzle body 10.

The valve body 20 is made of, for example, a metal material such as SUS, and is composed of one member from the rear end 21 to the front end 23. That is, the entire valve body 20 including the rear end 21, the front end 23, and the intermediate portion 22 between them is made of, for example, one material, and has no welded joints or mechanical joints such as screws between each part. More specifically the valve body 20 is manufactured by cutting, for example, one rod-shaped or columnar metal material by a lathe, a machining center, or the like, and grinding it with a centerless grinding machine or the like.

The plurality of rear end side sliding portions 211 of the rear end 21 of the valve body 20 is provided at intervals in the circumferential direction of the rear end 21, of the valve body 20, opposite to the front end 23 toward the injection hole 11 in the axial direction Da. The valve body 20 has, for example, three rear end side sliding portions 211 provided at intervals at the rear end 21 in the circumferential direction. The rear end 21 may have two rear end side sliding portions 211 in the circumferential direction, or may have four or more rear end side sliding portions 211 in the circumferential direction.

The engaging portion 213 consisting of an end of the rear end 21 adjacent to the movable core 30 in the axial direction Da, and the intermediate portion 22 between the rear end 21 and the front end 23 have a cylindrical outer peripheral face centered on the central axis A′ of the valve body 20 which is substantially coaxial with the central axis A of the nozzle body 10. Further, in the valve body 20, the outer diameter of the engaging portion 213, which is the end adjacent to the movable core 30 of the rear end 21, is larger than the outer diameter of the intermediate portion 22. As shown in FIG. 1 and FIG. 4, the intermediate portion 22 is inserted (with a gap) into (the valve body insertion hole 31 consisting of the through hole of) the movable core 30, whereby the rear end 21 engages the movable core 30.

The plurality of rear end side sliding portions 211 of the rear end 21 is provided, for example, at equal intervals at the rear end 21 in the circumferential direction. That is, as shown in FIG. 3, the angular intervals AS of the center 211c of the rear end side sliding portion 211 at rear end 21 in the circumferential direction are equal. For example, when three rear end side sliding portions 211 are provided at intervals at the rear end 21 in the circumferential direction, the angular intervals AS of the center 211c of the rear end side sliding portions 211 adjacent to each other via the flow path forming portion 212 at the rear end 21 in the circumferential direction are 120°. Further, when four rear end side sliding portions 211 are provided at intervals at the rear end 21 in the circumferential direction, the angular intervals AS of the center 211c of the rear end side sliding portions 211 adjacent to each other via the flow path forming portion 212 at the rear end 21 in the circumferential direction are 90°.

The rear end side sliding portion 211 of the rear end 21 is, for example, a portion, of the cylindrical rear end 21 of the valve body 20, that is left without being cut out, and has a partially cylindrical outer peripheral face. That is, the rear end side sliding portion 211 is composed of part of the outer peripheral face of the cylindrical rear end 21 having a plurality of cutouts. A plurality of flow path forming portions 212 is provided by cutting out part of the outer peripheral face of the cylindrical rear end 21.

The plurality of flow path forming portions 212 is provided between the adjacent rear end side sliding portion 211 and rear end side sliding portion 211, and is provided radially inside the rear end 21 relative to the rear end side sliding portions 211. As shown in FIG. 1 and FIG. 4, the flow path forming portion 212 has a fuel flow path FC between the rear end 21 of the valve body 20 and the inner peripheral face 41, of the cylindrical fixed core 40, into which the rear end 21 of the valve body 20 is inserted. When the rear end 21 has three rear end side sliding portions 211 in the circumferential direction, three flow path forming portions 212 are formed at the rear end 21. Further, when the rear end 21 has four rear end side sliding portions 211 in the circumferential direction, four flow path forming portions 212 are formed at the rear end 21. That is, the number of the rear end side sliding portions 211 and the number of the flow path forming portions 212 which are provided at the rear end 21 are equal. Further, when the plurality of rear end side sliding portions 211 is provided at equal intervals at rear end 21 in the circumferential direction, the plurality of flow path forming portions 212 is formed at equal intervals at the rear end 21 in the circumferential direction.

The flow path forming portion 212 has a flat face 212a provided between the adjacent rear end side sliding portion 211 and rear end side sliding portion 211. As shown in FIG. 3, for example, when the rear end 21 has three rear end sliding portions 211 at equal intervals in the circumferential direction, the angle of an included angle IA between the flat faces 212a, of the flow path forming portions 212, adjacent to each other via the rear end side sliding portion 211 is 60°. Further, for example, when the rear end 21 has four rear end side sliding portions 211 at equal intervals in the circumferential direction, the angle of the included angle IA between the flat faces 212a of the flow path forming portions 212 adjacent to each other via the rear end side sliding portion 211 is 90°. These are equal to the internal angle of an equilateral triangle and the internal angle of a square, respectively.

That is, when the rear end 21 has the plurality of rear end side sliding portions 211 at equal intervals in the circumferential direction, the angle of the included angle IA between the flat faces 212a of the flow path forming portions 212 adjacent to each other via the rear end side sliding portion 211 is equal to the internal angle of a regular polygon having the number of vertices same as the number of the rear end side sliding portions 211.

In addition, in the examples shown in FIG. 2 and FIG. 3, the angle range AR2 of the portion where the flow path forming portion 212 is formed is larger than the angle range AR1 of the portion where the rear end side sliding portion 211 is formed in the circumferential direction of the rear end 21. That is, of the cylindrical outer peripheral face of the rear end 21 toward the coil spring 61 relative to the engaging portion 213, less than half the outer peripheral face is left as a partial cylindrical face constituting the rear end side sliding portion 211. In other words, the flow path forming portion 212 is formed by cutting out half the outer peripheral face or more of the cylindrical outer peripheral face of the rear end 21 toward the coil spring 61 relative to the engaging portion 213.

The engaging portion 213 is provided toward the front end of the valve body 20 relative to the flow path forming portion 212, and is provided so as to project radially outward of the flow path forming portion 212. Further, in the examples shown in FIG. 2 and FIG. 3, the engaging portion 213 has a cylindrical outer peripheral face that is continuously connected to the outer peripheral face of the rear end side sliding portion 211 over the entire circumference of the rear end 21 in the circumferential direction without any step. That is, the end face, of the engaging portion 213, facing the movable core 30 has the outer peripheral face of the engaging portion 213, which is the end of the rear end 21 of the valve body 20 toward the movable core 30, as the outer peripheral edge, and is an annular end face having an outer peripheral face 221 of the intermediate portion 22 of the valve body 20 as an inner peripheral edge.

Further, in the examples shown in FIG. 1 and FIG. 4, the engaging portion 213 has an outer diameter which is smaller than the inner diameter (hole diameter) of a through hole 42 provided in the center of the fixed core 40, and is provided so as to be movable inside the fixed core 40 in the axial direction Da. The clearance between the outer peripheral face of the rear end 21 of the valve body 20, that is, the outer peripheral face of the engaging portion 213 and the rear end side sliding portion 211, and the inner peripheral face 41 of the fixed core 40 is, for example, about 10 μm to 30 μm, more preferably about 20 μm to 30 μm.

The intermediate portion 22 of the valve body 20 has a stepped shaft shape and is composed of the relatively large diameter insertion portion 222 which is slidably inserted into (the valve body insertion hole 31 consisting of the through hole of) the movable core 30 and the neck 223 having a relatively small diameter (constant outer diameter) extending in the axial direction Da from the insertion portion 221 to the front end 23. In other words, the neck 223 is located toward the front end (downstream side) relative to the insertion portion 22 and toward the rear end (upstream side) relative to (the spherical portion 230 of) the front end 23. The neck 223 has the gap G1 between the inner peripheral face 16 of the nozzle body 10 and is inserted (disposed inside) in the nozzle body 10.

As shown in FIG. 1 and FIG. 5, the front end of the front end 23 of the valve body 20 is a spherical portion 230, and the outermost diameter (sphere diameter) of the spherical portion 230 is smaller than the outer diameter of the insertion portion 222 of the intermediate portion 22 and larger than the outer diameter of the neck 223 of the intermediate portion 22. The front end 23 of the valve body 20 is received by the concave front end member 12 provided at the front end of the cylindrical nozzle body 10, and the front end side sliding portion 231 is composed of part of the outer peripheral face (spherical face) of the spherical portion 230 of the valve body 20, and slides in the axial direction Da in contact with the cylindrical inner peripheral face 121 of the recess 122 provided in the center of the bottom of the front end member 12 of the nozzle body 10. Further, for example, a plurality of cutouts 123 for forming the fuel flow path FC is provided at equal intervals at the recess 122 in the circumferential direction at the recess 122 provided in the center of the bottom of the front end member 12.

The valve body 20 is configured such that when the seat portion 232 provided toward the front end (in other words, downstream side) relative to the front end side sliding portion 231 of the spherical portion 230 located toward the front end of the front end 23 comes into contact with the seat face 124 provided at the front end member 12 of the nozzle body 10, the fuel flow path FC between the valve body 20 and the seat face 124 is closed, so that the injection hole 11 provided toward the front end relative to the seat face 124 is closed. Further, when the seat portion 232 is away from the seat face 124 provided at the front end member 12 of the nozzle body 10, the fuel flow path FC is formed between the valve body 20 and the seat face 124, so that the injection hole 11 provided toward the front end relative to the seat face 124 is opened. The valve body 20 has, for example, a projection 233 having a conical front end (in the illustrated example, a conical shape having an apex angle of about 90°) toward the front end relative to the seat portion 232 of the front end 23 in the axial direction Da.

The front end member 12 of the nozzle body 10 has, for example, the concave seat face 124, at the central portion of the recess 122 at the bottom, that receives (the front end of) the spherical portion 230 of the front end 23 of the valve body 20. The seat face 124 has a truncated cone shape (in the illustrated example, a truncated cone shape having an apex angle of about 90°) that gradually reduces in diameter toward the front end of the nozzle body 10 in the axial direction Da, and the injection hole 11 is opened. That is, when the seat face 124 and (the seat portion 232 of) the spherical portion 230 of the valve body 20 are in line contact with each other over the entire circumference of the seat face 124, the fuel flow path FC between the seat face 124 and the valve body 20 is closed. Further, when (the seat portion 232 of) the spherical portion 230 of the valve body 20 is away from the seat face 124, the fuel flow path FC is formed between the seat face 124 and the valve body 20, so that fuel is injected through the injection hole 11 that opens at the seat face 124. Further, the front end member 12 has, for example, a receiving recess 125 having a concave curved bottom toward the front end relative to the seat face 124 in the axial direction Da and at the central portion of the recess 122 at the bottom. The receiving recess 125 is provided so as to receive at least part (specifically, the front end) of the projection 233 at the front end of the valve body 20 in a state where the injection hole 11 is closed.

The fixed core 40 is a tubular member that attracts the movable core 30 by magnetic attraction force. More specifically, the fixed core 40 has a generally cylindrical shape having irregularities at the outer peripheral face.

The generally cylindrical coil bobbin 51 is disposed at the outer circumference of the front end of the fixed core 40. The coil 50 wound in a cylindrical shape is disposed at the outer circumference of the coil bobbin 51. The ends of the winding start and winding end of the coil 50 are connected to a power supply terminal 811 of a connector 81 of the resin portion 80 via wiring (not shown).

The fixed core 40 has the through hole 42 along the central axis A (in other words, substantially coaxial with the central axis A). The through hole 42 of the fixed core 40 forms the flow path FC for introducing fuel. For the purpose of improving the durability and reliability of the fixed core 40 that collides with the movable core 30, the front end face, of the fixed core 40, facing the movable core 30 may be coated with plating such as hard chrome plating or electroless nickel plating. An opening 43 for introducing fuel is provided at the rear end face of the fixed core 40 opposite to the front end face. From this opening 43, the filter 90 is inserted into the through hole 42 of the fixed core 40 and fixed.

The fixed core 40 has an enlarged diameter portion 44 whose diameter is increased as the vicinity of the front end face of the through hole 42 is close to the front end face. In other words, the fixed core 40 has a truncated cone-shaped enlarged diameter portion 44 at the cylindrical inner peripheral face 41 whose inner diameter increases as it is closer to the movable core 30. The enlarged diameter portion 44 is configured such that the cylindrical engaging portion 213 of the rear end 21 of the valve body 20 is housed, for example, in a valve closed state in which (the seat portion 232 of the front end 23 of) the valve body 20 is in contact with the seat face 124 and the injection hole 11 is closed.

That is, when the valve body 20 is at the valve closed position, the enlarged diameter portion 44 of the fixed core 40 is provided so as to overlap the position of the engaging portion 213 of the rear end 21 of the valve body 20 in the axial direction Da.

Further, the enlarged diameter portion 44 of the fixed core 40 is configured such that, for example, in a valve closed state in which the injection hole 11 is closed, at least part (specifically, the front end) of the flow path forming portion 212 of the rear end 21 of the valve body 20 is disposed inside the enlarged diameter portion 44, and the fuel flow path FC is formed between the flow path forming portion 212 and the inner peripheral face 41 of the fixed core 40. That is, when the valve body 20 is at the valve closed position, the enlarged diameter portion 44 of the fixed core 40 is provided so as to overlap at least part of the flow path forming portion 212 of the rear end 21 of the valve body 20 in the axial direction Da.

The adjustment member 62 is, for example, press-fitted into the through hole 42 of the fixed core 40 and fixed inside the fixed core 40. The coil spring 61 is disposed in the through hole 42 inside the fixed core 40, and is provided so as to urge the valve body 20 toward the injection hole 11 in the axial direction Da. More specifically the coil spring 61 is disposed in a compressed state between the adjustment member 62 fixed to the fixed core 40 and the rear end 21 of the valve body 20 inserted in (the through hole 42 of) the fixed core 40, and urges the valve body 20 toward the injection hole 11 in the axial direction Da. The initial load at which the coil spring 61 presses the front end 23 of the valve body 20 against the seat face 124 provided at the front end member 12 of the nozzle body 10 can be adjusted by adjusting the fixed position of the adjustment member 62 with respect to the fixed core 40. Further, the adjustment member 62 supports the coil spring 61 by the end portion toward the coil spring 61, thereby preventing the position of the coil spring 61 from shifting in the direction intersecting the axial direction Da.

In this example, the valve body 20 has a projection 214 that projects from the end face (that is, the rear end face) of the rear end 21 opposite to the movable core 30 in the axial direction Da and engages inside of the coil spring 61. The projection 214 is a generally columnar protrusion in which the corner portion of the front end is chamfered, and is provided so as to fit snugly inside the end of the coil spring 61 toward the valve body 20, thereby preventing the position of the coil spring 61 from shifting in the direction intersecting the axial direction Da. As a result, the coil spring 61 has a gap G2 between the coil spring 61 and the inner peripheral face 41 of the fixed core 40 and is held inside the fixed core 40.

The movable core 30 is a thick-walled cylindrical member that is engaged with the rear end 21 of the valve body 20 to move together with the valve body 20 in the axial direction Da. The movable core 30 is separate from the valve body 20 and has a valve body insertion hole 31 consisting of the through hole in the center thereof through which the valve body 20 is inserted in the axial direction Da. The inner diameter of the valve body insertion hole 31 (that is, the hole diameter of the through hole) is smaller than the outer diameter of the rear end 21 of the valve body 20 including the outer diameter of the engaging portion 213, and is slightly larger than the outer diameter of the portion (intermediate portion 22 and front end 23) toward the front end relative to the rear end 21 of the valve body 20, and the portion toward the front end relative to the rear end 21 of the valve body 20 is inserted into the valve body insertion hole 31. Further, the movable core 30 has an eccentric through hole 32, having a slightly smaller diameter than the valve body insertion hole 31, which penetrates the movable core 30 in the axial direction Da to form the fuel flow path FC at a position eccentric from the central valve body insertion hole 31. In addition, the side face (outer peripheral face) of the movable core 30 and the inner peripheral face of (the internal space 140 of the large diameter portion 14 of) the nozzle body 10 are not in contact with each other. That is, the movable core 30 has a gap G3 between the movable core 30 and the inner peripheral face of the nozzle body 10, and is movably inserted into the nozzle body 10.

For the purpose of improving the durability and reliability of the movable core 30 that collides with the fixed core 40, the upper end face or the collision face of the fixed core 40 facing the movable core 30 may be coated with plating such as hard chrome plating or electroless nickel plating. As a result, the durability and reliability of the movable core 30 can be ensured even when a relatively soft magnetic stainless steel is used as the material of the movable core 30.

The small coil spring 63 is housed in the internal space 140 of the large diameter portion 14 of the nozzle body 10. The small coil spring 63 is supported by the bottom of the recess 141 whose front end is provided at the central portion of the bottom of the internal space 140 of the large diameter portion 14, and whose rear end contacts the lower end face of the movable core 30 opposite to the fixed core 40, and is held in a compressed state between the movable core 30 and the nozzle body 10. As a result, the small coil spring 63 urges the movable core 30 toward the fixed core 40.

The housing 70 has a bottomed cylindrical shape, and the large diameter portion 14 of the nozzle body 10 is inserted into a bottom through hole 71 provided at the central portion of the bottom. The housing 70 is fixed to the large diameter portion 14 of the nozzle body 10 by welding a portion between the opening edge, of the bottom through hole 71, provided at the bottom and the outer peripheral face of the large diameter portion 14 of the nozzle body 10, for example, over the entire circumference. Further, the housing 70 is disposed so as to surround the front end of the fixed core 40, the coil bobbin 51, and the outer circumference of the coil 50. The inner peripheral face of the housing 70 faces the large diameter portion 14 of the nozzle body 10 and the coil 50 to form an outer peripheral yoke portion.

A space between the fixed core 40, the coil bobbin 51, and the coil 50, and the housing 70 is filled with the resin portion 80, which is molded so as to cover the outer peripheral face of the fixed core 40 except for the rear end and form the connector 81 having the terminal 811 for power supply. As described above, a toroidal magnetic passage including the fixed core 40, the movable core 30, the large diameter portion 14 of the nozzle body 10, and the housing 70 is formed around the coil 50.

Hereinafter, the operation of the fuel injection valve 1 according to the present embodiment will be described.

In the fuel injection valve 1, for example, the terminal 811 of the connector 81 is connected to the connection terminal of a plug (not shown) and connected to a high voltage power supply or a battery power supply, and the energization of the coil 50 is controlled by an engine control unit (ECU). The elastic force by which the coil spring 61 urges the valve body 20 toward the seat face 124 at the front end of the nozzle body 10 is larger than the elastic force by which the small coil spring 63 urges the movable core 30 toward the fixed core 40. For this reason, when the coil 50 is not energized, (the seat portion 232 of) the spherical portion 230 of the front end 23 of the valve body 20 is pressed against the seat face 124 of the front end member 12 of the nozzle body 10, and the flow path FC leading to the injection hole 11 provided at the seat face 124 is in a closed valve state (see FIG. 1 and FIG. 5).

When the coil 50 is energized by the ECU, magnetic flux flows through the magnetic circuit including the fixed core 40, the movable core 30, the large diameter portion 14 of the nozzle body 10, and the housing 70, and a magnetic attraction force that attracts the movable core 30 to the fixed core 40 is generated.

When the magnetic attraction force of the fixed core 40 exceeds the set load of the coil spring 61, the movable core 30 moves toward the fixed core 40. The movable core 30 moves until the end face (the rear end face) facing the fixed core 40 collides with the front end face of the fixed core 40. At this time, the movable core 30 is engaged with the rear end 21 of the valve body 20 to move the valve body 20 in the axial direction Da toward the fixed core 40.

When the valve body 20 moves in the axial direction Da toward the fixed core 40, (the seat portion 232 of) the spherical portion 230 of the front end 23 of the valve body 20 is separated from the seat face 124 of the front end member 12 of the nozzle body 10, the flow path FC leading to the injection hole 11 between the valve body 20 and the seat face 124 is opened, and the injection hole 11 is opened. In the fuel injection valve 1, when the valve body 20 is at such an open position, the fuel supplied from the opening 43 at the rear end of the fixed core 40 through the filter 90 flows along the axial direction Da toward the front end of the nozzle body 10 through the through hole 42 of the fixed core 40.

The fuel further passes through the adjustment member 62 and the coil spring 61 disposed in the through hole 42 of the fixed core 40, flows through the flow path FC formed between the flow path forming portion 212 of the rear end 21 of the valve body 20 and the inner peripheral face 41 of the through hole 42 of the fixed core 40, and flows into the internal space 140 of the large diameter portion 14 of the nozzle body 10 through the eccentric through hole 32 of the movable core 30. The fuel that has flowed into the internal space 140 of the large diameter portion 14 of the nozzle body 10 flows between the intermediate portion 22 of the valve body 20 and the inner peripheral face 16 of the small diameter portion 13 of the nozzle body 10 (gap G1), flows through the flow path FC formed between (the seat portion 232 of) the spherical portion 230 of the front end 23 of the valve body 20 and the seat face 124 of the front end member 12, and is injected into the combustion chamber of the internal combustion engine through the injection hole 11 opened in the seat face 124.

When the energization of the coil 50 is interrupted by the ECU, the magnetic flux flowing through the magnetic circuit including the fixed core 40, the movable core 30, the large diameter portion 14 of the nozzle body 10, and the housing 70 disappears, and the magnetic attraction force, of the fixed core 40, that attracts the movable core 30 disappears. Then, the operation returns to an initial state in which the elastic force by which the coil spring 61 urges the valve body 20 toward the seat face 124 at the front end of the nozzle body 10 is larger than the elastic force by which the small coil spring 63 urges the movable core 30 toward the fixed core 40.

As a result, the rear end 21 of the valve body 20 is urged by the coil spring 61, the movable core 30 engaged with the rear end 21 of the valve body 20 and the valve body 20 both move toward the front end of the nozzle body 10 in the axial direction Da, and a spherical portion 232 of the front end 23 of the valve body 20 comes into contact with the seat face 124 of the front end member 12 of the nozzle body 10. As a result, the flow path FC between (the seat portion 232 of) the spherical portion 230 of the front end 23 of the valve body 20 and the seat face 124 of the nozzle body 10 is closed, the injection hole 11 is closed by the valve body 20, and the injection of fuel through the injection hole 11 is stopped.

As described above, the valve body 20 includes the plurality of rear end side sliding portions 211, the plurality of flow path forming portions 212, and the engaging portion 213. The plurality of rear end side sliding portions 211 is provided at intervals at the rear end 21 in the circumferential direction. The plurality of flow path forming portions 212 is provided between the adjacent rear end side sliding portion 211 and rear end side sliding portion 211, and is radially inside the rear end 21 relative to the rear end side sliding portions 211. The engaging portion 213 is provided toward the front end of the valve body 20 relative to the flow path forming portion 212, and projects radially outward of the flow path forming portion 212. The valve body 20 is configured such that when the injection hole 11 is opened and closed, at least one of the plurality of rear end side sliding portions 211 comes into contact with the inner peripheral face 41 of the fixed core 40 to slide in the axial direction Da, and the end face, of the engaging portion 213, facing the movable core 30 comes into contact with the movable core 30.

With this configuration, when opening and closing the injection hole 11, that is, when opening and closing the flow path FC leading to the injection hole 11 between the valve body 20 and the seat face 124, at least one of the plurality of rear end side sliding portions 211 of the rear end 21 of the valve body 20 can be guided in the axial direction Da by the inner peripheral face 41 of the fixed core 40. Therefore, the movement of the valve body 20 in the axial direction Da can be stabilized by defining the radial position of the valve body 20, and the amount of fuel injected can be made uniform as compared with the conventional case.

In addition, wear of the rear end side sliding portion 211 is suppressed, and the durability of the valve body 20 is improved. More specifically, when the coil spring 61 urges the movable core 30 toward the front end of the nozzle body 10, not only the force in the axial direction Da, but also the radial force of the valve body 20 acts on the rear end 21 of the valve body 20 by the coil spring 61. However, in this example, the plurality of rear end side sliding portions 211 that is in contact with the inner peripheral face 41 of the fixed core 40 and slides in the axial direction Da is provided at rear end 21 of the valve body 20 in the circumferential direction, so that the valve body 20 can be supported and guided by the inner peripheral face 41 of the fixed core 40 at the rear end 21, of the valve body 20, on which a radial force acts from the coil spring 61. For this reason, the distance between the position where the radial force acts on the valve body 20 and the rear end side sliding portion 211 in the axial direction Da can be made close, and the radial load, of the valve body 20, acting on the rear end side sliding portion 211 can be dynamically reduced.

Further, the engaging portion 213 of the rear end 21 of the valve body 20 projects radially outward of the flow path forming portion 212, so that the area of the face of the rear end 21 of the valve body 20 facing the movable core 30 can be increased, compared to the case without the engaging portion 213. As a result, the force per unit area acting between the rear end 21 of the valve body 20 and the movable core 30 can be reduced, and the durability can be improved as compared with the conventional case.

As described above, the fuel injection valve 1 of the present embodiment has the following configuration as the first feature. The configuration has a shape relationship in which φB>φC>φD>φE>φF is satisfied where φB represents a hole diameter of a valve body insertion hole 31 consisting of the through hole formed in the central axis of the movable core 30, φC represents an outer diameter of an intermediate portion 22, of the valve body 20, that slides on the valve body insertion hole (through hole) 31, φD represents a diameter of sliding with a front end member 12 having the injection hole 11 that slides on the front end side sliding portion 231 of the front end side (downstream side) spherical portion 230 of the valve body 20, φE represents an outermost diameter (sphere diameter) of the front end side sliding portion 231 of the front end side (downstream side) spherical portion 320 of the valve body 20, and φF represents an outer diameter of a neck 223, the smallest diameter portion, which is located toward the rear end (upstream) relative to the front end side (downstream side) spherical portion 230 of the valve body 20 and located at the intermediate portion 22 of the valve body 20, and a side face of the movable core 30 and the inner peripheral face of the nozzle body 10 are not in contact with each other, and the gap G3 exists in any situation. In other words, the front end 23 of the valve body 20 has the spherical portion 230 having the front end side sliding portion 231 that slides on the inner peripheral face of the front end member 12 of the nozzle body 10, the intermediate portion 22 between the front end 23 and the rear end 21 of the valve body 20 has an insertion portion 222 that is inserted into the valve body insertion hole 31 consisting of the through hole formed in the movable core 30 and that slides on the valve body insertion hole (through hole) 31, and the neck 223 located downstream of the insertion portion 222 and upstream of the spherical portion 230, and the configuration has a shape relationship in which φB>φC>φD>φE>φF is satisfied where φB represents a hole diameter of the valve body insertion hole (through hole) 31 formed at the central axis of the movable core 30, φC represents an outer diameter of the insertion portion 222 at the intermediate portion 22, of the valve body 20, that slides on the valve body insertion hole (through hole) 31, φD represents a diameter of the inner peripheral face, of the front end member 12 of the nozzle body 10, that slides on the front end side sliding portion 231 of the spherical portion 230 of the valve body 20, φE represents an outermost diameter (sphere diameter) of the front end side sliding portion 231 of the spherical portion 230 of the valve body 20, and φF represents an outer diameter of the neck 223 at the intermediate portion 22 of the valve body 20, and a side face of the movable core 30 and the inner peripheral face of the nozzle body 10 are not in contact with each other (see FIG. 6).

With this configuration, the valve body 20 can be inserted from the filter 90 side located upstream after the fuel flow path FC of the fuel injection valve 1 is manufactured. In other words, since the fuel injection valve 1 without the valve body 20 can be cleaned with a large fuel passage FC secured, it has an excellent contamination emission performance and serious accidents such as a case in which fuel being left ejected can be avoided. Therefore, the reliability of the fuel injection valve 1 is improved. In addition, in order to comply with exhaust gas regulations that are becoming stricter year by year, it is necessary to operate even at high fuel pressure, and for this purpose, the outer diameter of the nozzle body 10 is required to be reduced. That is, the outer diameter of the nozzle body 10 can be reduced by satisfying the above-mentioned relationship of φB>φC>φD>φE>φF. Furthermore, since the configuration has the shape relationship in which the side face of the movable core 30 and the inner peripheral face of the nozzle body 10 do not come into contact with each other, there is no resistance generated when the movable core 30 comes into contact with the nozzle body 10, so that the variation in amount of fuel injected is smaller, and durability is also improved due to no wear.

Further, as described above, the fuel injection valve 1 of the present embodiment has the following configuration as a second feature. The valve body 20 is composed of one member from the rear end 21 to the front end 23. Further, the front end 23 of the valve body 20 has the spherical portion 230, and a front end side sliding portion 231 of the spherical portion 230 that slides on an inner peripheral face 121 of the front end member 12 of the nozzle body 10 and a seat portion 232, of the spherical portion 230, that contacts (is seated on) a seat face 124 of the front end member 12 of the nozzle body 10 are formed of the same spherical face.

With this configuration, when opening and closing the injection hole 11, that is, when opening and closing the flow path FC leading to the injection hole 11 by the valve body 20, at least one of the plurality of rear end side sliding portions 211 of the rear end 21 of the valve body 20 can be guided by the inner peripheral face 41 of the fixed core 40. Therefore, the movement of the valve body 20 in the axial direction Da can be stabilized by defining the radial position of the valve body 20, and the amount of fuel injected can be made uniform as compared with the conventional case. Further, since the valve body 20 is composed of one member from the rear end 21 to the front end 23, a plurality of functions of guiding the valve body 20 by the rear end side sliding portion 211, and forming the fuel flow path FC by the flow path forming portion 212 can be integrated into one component. Therefore, the number of components can be reduced, the productivity can be improved, and the manufacturing cost can be reduced. Further, since the front end side sliding portion 231 of the valve body 20 is a sphere, the area where the valve body 20 contacts the inner peripheral face 121 of the recess 122 of the front end member 12 does not change regardless of the degree of inclination, so that the amount of fuel injected can be made uniform. Also, since the sliding clearance is constant, it is possible to relax the coaxial tolerance of the inner peripheral face 121 of the recess 122 of the front end member 12, improving productivity and reducing the manufacturing cost.

Further, as described above, the fuel injection valve 1 of the present embodiment has the following configuration as a third feature. The nozzle body 10 has the concave front end member 12 which has the injection hole 11 and receives the front end 23 of the valve body 20. The valve body 20 is composed of one member from the rear end 21 to the front end 23, and has a rear end side sliding portion 211 and a front end side sliding portion 231 at the rear end 21 and the front end 23, respectively. The valve body 20 is configured such that when the injection hole 11 is opened and closed, the rear end side sliding portion 211 of the rear end 21 contacts an inner peripheral face 41 of the fixed core 40 to slide in the axial direction Da, and the front end side sliding portion 231 of the front end 23 contacts the inner peripheral face 121 of a recess 122 of the front end member 12 to slide in the axial direction Da.

With this configuration, when opening and closing the injection hole 11, that is, when opening and closing the flow path FC leading to the injection hole 11 by the valve body 20, at least one of the plurality of rear end side sliding portions 211 of the rear end 21 of the valve body 20 can be guided by the inner peripheral face 41 of the fixed core 40. At the same time, the front end side sliding portion 231 of the front end 23 of the valve body 20 can be guided by the inner peripheral face 121 of the recess 122 of the front end member 12. That is, the valve body 20 extending in the axial direction Da can be guided at the same time by the front end 23 and the rear end 21 in the axial direction Da. During the valve closed position at which the spherical portion 230 of the front end 23 of the valve body 20 contacts the seat face 124 of the front end member 12 of the nozzle body 10, the valve body 20 may be configured such that the only rear end side sliding portion 211 of the rear end 21 is supported by the inner peripheral face 41 of the fixed core 40, and the front end side sliding portion 231 of the front end 23 does not have to come into contact with the inner peripheral face 121 of the recess 122 of the front end member 12.

In this way, the valve body 20 includes the rear end side sliding portion 211 and the front end side sliding portion 231 at the front end 23 and the rear end 21 in the axial direction Da, respectively, so that the contact area between the rear end side sliding portion 211 of the rear end 21 and the inner peripheral face 41 of the fixed core 40, and the contact area between the front end side sliding portion 231 of the front end 23 and the inner peripheral face 121 of the recess 122 of the front end member 12 can be made more uniform between individual fuel injection valves 1. As a result, the amount of fuel injected between the individual fuel injection valves 1 can be made more uniform. Also, the front end side sliding portion 231 is formed at a position close to the seat face 124, of the front end member 12, in contact with the spherical portion 230 of the front end 23 of the valve body 20 in addition to a sliding portion at the rear end 21 of the valve body 20, so that the amount of tilt of the valve body 20 with respect to the central axis A of the nozzle body 10, that is, the inclination angle, can be reduced.

By reducing the amount of tilt of the valve body 20, that is, the inclination angle, the flow of the fluid is less likely to change for each injection, and the amount of fuel injected can be made uniform. In addition, the radial position of the valve body 20 can be defined more accurately, the movement of the valve body 20 in the axial direction Da can be made more stable, and the amount of fuel injected can be made more uniform. Further, since the valve body 20 is composed of one member from the rear end 21 to the front end 23, a plurality of functions of guiding the valve body 20 by the rear end side sliding portion 211 and the front end side sliding portion 231, and forming the fuel flow path FC by the flow path forming portion 212 can be integrated into one component. Therefore, the number of components can be reduced, the productivity can be improved, and the manufacturing cost can be reduced.

Further, in the fuel injection valve 1 of the present embodiment, as described above, the valve body 20 has three rear end side sliding portions 211 at intervals at the rear end 21 in the circumferential direction. With this configuration, the area of the outer peripheral face, of the rear end side sliding portion 211, that slides in contact with the inner peripheral face 41 of the fixed core 40 can be made larger than that when the number of the rear end side sliding portions 211 is two or four or more. Thereby, it is possible to guarantee the wear resistance of the rear end side sliding portion 211 of the rear end 21 that satisfies the number of operations required for the valve body 20. Therefore, it is possible to provide the fuel injection valve 1 capable of improving durability as compared with the conventional case.

Also, the range of the flow path forming portion 212 between the adjacent rear end side sliding portion 211 and rear end side sliding portion 211 can be increased at the rear end 21 of the valve body 20, so that it is possible to increase the cross-sectional area of the fuel flow path FC between the flow path forming portion 212 and the fixed core 40. As a result, it is possible to provide the fuel injection valve 1 capable of reducing the pressure loss in the fuel flow path FC formed by the flow path forming portion 212, and making the amount of fuel injected uniform as compared with the conventional case.

Further, in the fuel injection valve 1 of the present embodiment, the rear end side sliding portions 211 of the rear end 21 of the valve body 20 are provided at equal intervals at rear end 21 in the circumferential direction. With this configuration, the cross-sectional area of the fuel flow path FC formed by the flow path forming portion 212 between the adjacent rear end side sliding portion 211 and rear end side sliding portion 211 can be made uniform, and the pressure acting on the flow path forming portion 212 can be equalized by the fuel which is a fluid. Further, for example, when a radial force of the valve body 20 acts on the valve body 20 from the coil spring 61, only one of the rear end side sliding portions 211 comes into contact with the fixed core 40. For this reason, the other two rear end side sliding portions 211 of the rear end 21 of the valve body 20 do not contact the fixed core 40, the sliding area and sliding resistance between the rear end 21 of the valve body 20 and the fixed core 40 are kept constant, and the amount of fuel injected for each fuel injection by the fuel injection valve 1 can be made uniform.

Further, the fuel injection valve 1 of the present embodiment includes the coil spring 61 that urges the valve body 20 toward the injection hole 11 in the axial direction Da. The valve body 20 has the projection 214 that projects from the end face (that is, the rear end face) of the rear end 21 opposite to the movable core 30 in the axial direction Da and engages inside of the coil spring 61. With this configuration, the projection 214 of the rear end 21 of the valve body 20 can suppress the radial movement of the coil spring 61 to suppress the contact between the coil spring 61 and the inner peripheral face 41 of the fixed core 40. As a result, it is possible to eliminate the non-uniformity of the reciprocating motion of the valve body 20 due to the contact position and contact pressure of the coil spring 61 and the fixed core 40 being different between individual fuel injection valves 1. Therefore, it is possible to provide the fuel injection valve 1 that can improve durability as compared with the conventional case and can make the amount of fuel injected uniform.

Further, in the fuel injection valve 1 of the present embodiment, the coil spring 61 has the gap G2 between the coil spring 61 and the inner peripheral face 41 of the fixed core 40. With this configuration, contact between the coil spring 61 and the fixed core 40 can be prevented, and the uniformity of the reciprocating motion of the valve body 20 can be improved. Therefore, it is possible to provide the fuel injection valve 1 that can improve durability as compared with the conventional case and can make the amount of fuel injected uniform.

Further, in the fuel injection valve 1 of the present embodiment, the rear end side sliding portion 211 of the rear end 21 of the valve body 20 has a partially cylindrical outer peripheral face, and the flow path forming portion 212 has the flat face 212a provided between the rear end side sliding portions 211 of the rear end 21. With this configuration, the contact area between the inner peripheral face 41 of the cylindrical fixed core 40 and the rear end side sliding portion 211 of the rear end 21 of the valve body 20 can be increased to improve wear resistance of the rear end side sliding portion 211, and improve the durability of the fuel injection valve 1 as compared with the conventional case. Further, it is possible to form the flow path FC whose cross-sectional shape (cross-sectional shape perpendicular to the axial direction Da) is defined by an arc and a chord between the flat face 212a of the flow path forming portion 212 and the inner peripheral face 41 of the cylindrical fixed core 40, so that the cross-sectional area of the flow path FC can be increased to reduce the flow path resistance, and make the amount of fuel injected of the fuel injection valve 1 uniform.

Further, in the fuel injection valve 1 of the present embodiment, the angle of the included angle IA between the flat faces 212a of the flow path forming portions 212 adjacent to each other via the rear end side sliding portion 211 of the rear end 21 of the valve body 20 is 60°. With this configuration, the range of the flow path forming portion 212 between the adjacent rear end side sliding portion 211 and rear end side sliding portion 211 can be increased at the rear end 21 of the valve body 20, so that it is possible to increase the cross-sectional area of the fuel flow path FC between the flow path forming portion 212 and the fixed core 40. As a result, it is possible to provide the fuel injection valve 1 capable of reducing the pressure loss in the fuel flow path FC formed by the flow path forming portion 212, and making the amount of fuel injected uniform as compared with the conventional case. Further, the cross-sectional shape of the portion, of the rear end 21 of the valve body 20, where the flow path forming portion 212 is formed can be made into a substantially equilateral triangular shape having an arc-shaped apex portion. As a result, the strength of the rear end 21 of the valve body 20 can be ensured, and the durability of the fuel injection valve 1 can be improved.

Further, in the fuel injection valve 1 of the present embodiment, the angle range AR2 of the portion where the flow path forming portion 212 is formed is larger than the angle range AR1 of the portion where the rear end side sliding portion 211 is formed in the circumferential direction of the rear end 21 of the valve body 20. With this configuration, the range of the flow path forming portion 212 between the adjacent rear end side sliding portion 211 and rear end side sliding portion 211 can be increased at the rear end 21 of the valve body 20, so that it is possible to increase the cross-sectional area of the fuel flow path FC between the flow path forming portion 212 and the fixed core 40. As a result, it is possible to provide the fuel injection valve 1 capable of reducing the pressure loss in the fuel flow path FC formed by the flow path forming portion 212, and making the amount of fuel injected uniform as compared with the conventional case. Further, the cross-sectional shape of the portion, of the rear end 21 of the valve body 20, where the flow path forming portion 212 is formed can be made into a substantially equilateral triangular shape having an arc-shaped apex portion. As a result, the strength of the rear end 21 of the valve body 20 can be ensured, and the durability of the fuel injection valve 1 can be improved.

Further, in the fuel injection valve 1 of the present embodiment, as described above, the rear end side sliding portion 211 of the rear end 21 of the valve body 20 has a partially cylindrical outer peripheral face, and the flow path forming portion 212 has the flat face 212a provided between the rear end side sliding portions 211. Further, the engaging portion 213 of the rear end 21 of the valve body 20 has a cylindrical outer peripheral face that is provided toward the front end of the valve body 20 relative to the flow path forming portion 212, that projects radially outward of the flow path forming portion 212, that is continuous over the entire circumference of the rear end 21 in the circumferential direction, and that is flush with the outer peripheral face of the rear end side sliding portion 211.

In this way, the engaging portion 213 of the rear end 21 of the valve body 20 projects radially outward of the flow path forming portion 212, so that the area of the face of the rear end 21 of the valve body 20 in contact with the movable core 30 can be increased, compared to the case without the engaging portion 213. Further, the engaging portion 213, which is the end of the rear end 21 toward the movable core 30, has a cylindrical outer peripheral face that is continuous over the entire circumference of the rear end 21 in the circumferential direction, and that is flush with the outer peripheral face of the rear end side sliding portion 211, so that the area of the face in contact with the movable core 30 can be maximized. As a result, the force per unit area acting between the rear end 21 of the valve body 20 and the movable core 30 can be reduced, and the durability can be improved as compared with the conventional case.

In addition, the valve body 20 can be rotated and cut by a lathe or a machining center, which not only facilitates the manufacture of the valve body 20 but also reduces man-hours in the manufacturing process, improves productivity, and reduces the manufacturing cost.

Specifically, burrs may occur at the corner between the outer peripheral face of the engaging portion 213 of the valve body 20 manufactured by rotary cutting and the face facing the movable core 30.

However, the engaging portion 213 has a cylindrical outer peripheral face that is continuous over the entire circumference of the rear end 21 in the circumferential direction, so that the rear end 21 of the valve body 20 can be rotated to remove burrs at the corner in one process. On the other hand, when the cross-sectional shape of the end of the valve body 20 toward the movable core 30 is non-circular, the burrs on the corner cannot be removed in one process, so that the productivity of the valve body 20 may be reduced, and the manufacturing costs may increase.

Further, the fuel injection valve 1 of the present embodiment has a configuration in which the fixed core 40 has the enlarged diameter portion 44 whose inner diameter increases at the inner peripheral face 41 as it is close to the movable core 30, and the enlarged diameter portion 44 houses the engaging portion 213 of the rear end 21 of the valve body 20 (with a gap) in a state where the injection hole 11 is closed. As a result, a gap can be formed between the engaging portion 213 of the rear end 21 of the valve body 20 and the enlarged diameter portion 44 of the inner peripheral face 41 of the fixed core 40 to form the fuel flow path FC. Therefore, it is possible to reduce the pressure loss of fuel flowing between the engaging portion 213 of the rear end 21 of the valve body 20 and the enlarged diameter portion 44 of the inner peripheral face 41 of the fixed core 40, so that the amount of fuel injected of the fuel injection valve 1 can be made uniform.

Further, in the fuel injection valve 1 of the present embodiment, at least part of the flow path forming portion 212 is disposed inside the enlarged diameter portion 44 in a state where the injection hole 11 is closed. More specifically, the end (front end) of the flow path forming portion 212 toward the movable core 30 is housed in the enlarged diameter portion 44 in the fuel injection valve 1 of the present embodiment, in a state in which the flow path FC, between the front end 23 and the seat face 124 of the valve body 20, leading to the injection hole 11 is closed. As a result, the cross-sectional area of the fuel flow path FC between the flow path forming portion 212 of the rear end 21 of the valve body 20 and the enlarged diameter portion 44 of the inner peripheral face 41 of the fixed core 40 can be enlarged. Therefore, the pressure loss of the fuel flowing between the rear end 21 of the valve body 20 and the inner peripheral face 41 of the fixed core 40 can be reduced, and the amount of fuel injected of the fuel injection valve 1 can be made uniform.

Further, the fuel injection valve 1 of the present embodiment has a portion (that is, an engaging portion 213) adjacent to the movable core 30 of the rear end 21 in the axial direction Da, and the intermediate portion 22 between the rear end 21 and the front end 23 has a cylindrical outer peripheral face centered on the central axis A′ of the valve body 20. With this configuration, the entire valve body 20, that is, the rear end 21, the intermediate portion 22 and the front end 23 of the valve body 20, can be formed by cutting, for example, one columnar or round bar-shaped metal material. In this way, the entire valve body 20 consists of one component obtained by cutting one material, so that it is possible to improve the dimensional accuracy of the valve body 20, to improve productivity and to reduce the manufacturing cost of the valve body 20. Furthermore, compared to the case where respective components of the valve body 20 are manufactured as separate components and integrated by press fitting or welding, it is possible to suppress the generation of foreign matter such as metal pieces generated during press fitting and spatter generated during welding. As a result, it is possible to suppress the occurrence of malfunctions of the valve body 20 such as fuel leakage due to foreign matter, and it is possible to make the amount of fuel injected of the fuel injection valve 1 uniform.

Further, in the valve body 20 of the fuel injection valve 1 of the present embodiment, the outer diameter of the portion (that is, the engaging portion 213), of the rear end 21, adjacent to the movable core 30 is larger than the outer diameter of the intermediate portion 22 between the rear end 21 and the front end 23, and the intermediate portion 22 is inserted into (the valve body insertion hole 31 of) the movable core 30. That is, the inner diameter of the valve body insertion hole 31 of the movable core 30 is larger than the outer diameter of the intermediate portion 22 of the valve body 20 and smaller than the outer diameter of the engaging portion 213 of the rear end 21 of the valve body 20.

With this configuration, in the valve closed state of the fuel injection valve 1 in which the urging force of the coil spring 61 acting on the rear end 21 of the valve body 20 toward the front end of the nozzle body 10 is larger than the urging force of the small coil spring 63 that urges the movable core 30 toward the fixed core 40, the end of the rear end 21 of the valve body 20 toward the movable core 30 is in contact and engages with the movable core 30. When the movable core 30 moves toward the fixed core 40 in the axial direction Da by the urging force of the small coil spring 63 and the magnetic attraction force of the fixed core 40, the valve body 20 together with the movable core 30 moves in the axial direction Da so as to be away from the seat face 124 of the front end member 12 of the nozzle body 10.

The movable core 30 collides with the front end face of the fixed core 40, the movable core 30 bounces off toward the front end, of the nozzle body 10, opposite to the fixed core 40, that is, toward the fuel downstream side. On the other hand, the valve body 20 inserted into the valve body insertion hole 31 of the movable core 30 continues to move the fuel upstream away from the injection hole 11 even after the movable core 30 collides with the fixed core 40.

In other words the valve body 20 overshoots towards the rear end of the fixed core 40, which is fuel upstream from the position of the rear end face of the movable core 30, and is subsequently urged by the coil spring 61, so that it moves toward the front end of the nozzle body 10 again, which is fuel downstream. For this reason, when the coil 50 is energized, the valve body 20 engages with the movable core 30 whose rear end 21 is attracted to the fixed core 40, and stands still at the open valve opening position at which the flow path FC between (the seat portion 232 of) the spherical portion 230 of the front end 23 and the seat face 124 is opened.

In addition, when the energization of the coil 50 is interrupted, and the magnetic attraction force of the fixed core 40 disappears, the movable core 30 engaged with the rear end 21 of the valve body 20 moves together with the valve body 20 toward the front end of the nozzle body 10 in the axial direction Da by the urging force of the coil spring 61 acting on the rear end 21 of the valve body 20. When (the seat portion 232 of) the spherical portion 230 of the front end 23 of the valve body 20 collides with the seat face 124 of the front end member 12 of the nozzle body 10, the movable core 30 continues to move toward the front end of the nozzle body 10 by inertial force because it is separated from the valve body 20. Further, the valve body 20 rebounds in the valve opening direction after (the seat portion 232 of) the spherical portion 230 of the front end 23 collides with the seat face 124 of the front end member 12 of the nozzle body 10.

At this time, friction due to a fluid is generated between the inner peripheral face of the valve body insertion hole 31 of the movable core 30 and the outer peripheral face of (the intermediate portion 22 of) the valve body 20 inserted into the valve body insertion hole 31, and kinetic energy is converted into frictional energy to be reduced. Further, since the movable core 30 having a relatively large inertial mass is formed separately from the valve body 20, the kinetic energy generated when the valve body 20 collides with the seat face 124 is reduced. As a result, the rebound of the valve body 20 after colliding with the seat face 124 is reduced.

Further, the inertial force acting on the movable core 30 is smaller than that in the case where the movable core 30 and the valve body 20 are integrated. Therefore, the repulsive force received after compressing the small coil spring 63 is small. Therefore, the rebound of the movable core 30 toward the valve opening direction, that is, the fixed core 40 is suppressed, and the phenomenon that the valve body 20 collides with the seat face 124 and then is moved again in the valve opening direction is less likely to occur. As a result, the rebound of the valve body 20 is minimized, and the so-called secondary injection phenomenon in which after the energization of the coil 50 is interrupted, the flow path FC between the valve body 20 and the seat face 124 is opened, and the fuel is randomly injected can be suppressed to reduce emissions.

Further, in the fuel injection valve 1 of the present embodiment, the engaging portion 213 of the rear end 21 of the valve body 20 has an outer diameter smaller than the inner diameter of the fixed core 40, and is provided so as to be movable inside the fixed core 40 in the axial direction Da. With this configuration, after cleaning the through hole 42 of the cylindrical fixed core 40 to remove foreign matter that may cause fuel leakage, the front end member 12, the valve body 20, the coil spring 61, the adjustment member 62, and the filter 90 can be inserted in the axial direction Da from the through hole 42 of the fixed core 40 and assembled. Therefore, the fuel injection valve 1 makes it possible to not only reduce the possibility of fuel leakage due to foreign matter, but also simplify the manufacturing process to improve productivity.

Further, in the fuel injection valve 1 of the present embodiment, the valve body 20 has the gap G1 between the outer peripheral face 221 of the intermediate portion 22 between the rear end 21 and the front end 23 and the inner peripheral face 16 of the nozzle body 10. With this configuration, the frictional resistance between the nozzle body 10 and the valve body 20 can be reduced, and the valve body 20 can be easily moved in the axial direction Da. Therefore, the durability of the fuel injection valve 1 can be improved, and the amount of fuel injected can be made uniform.

Further, in the fuel injection valve 1 of the present embodiment, the valve body 20 has the conical projection 233 toward the front end of the front end 23 in the axial direction Da relative to the front end side sliding portion 231. Further, the front end member 12 of the nozzle body 10 has the concave seat face 124 that receives (the front end of) the spherical portion 230, and has the receiving recess 125 that receives at least part of the projection 233 of the valve body 20 toward the front end relative to the seat face 124. The seat face 124 has a truncated cone shape that gradually reduces in diameter toward the front end of the nozzle body 10 in the axial direction Da, and the injection hole 11 is opened at the downstream side of the seat face 124.

With this configuration, while guiding the front end 23 of the valve body 20 by the front end side sliding portion 231 provided on the front end 23, the seat portion 232 toward the front end of the valve body 20 relative to the front end side sliding portion 231 can be brought into contact with the seat face 124 of the front end member 12 of the nozzle body 10, or can be separated from the seat face 124. As a result, the operation of the valve body 20 when the injection hole 11 is opened and closed can be stabilized, the durability of the fuel injection valve 1 can be improved, and the amount of fuel injected can be made uniform. Further, when the fuel injection valve 1 is closed, (the seat portion 232 of) the spherical portion 230 of the front end 23 of the valve body 20 and the seat face 124 of the front end member 12 of the nozzle body 10 can be generally line-contacted over the entire circumference of the valve body 20 in the circumferential direction. As a result, the durability of the fuel injection valve 1 can be improved and the amount of fuel injected can be made uniform.

As explained above, according to the embodiments of the present disclosure, it is possible to provide a fuel injection valve 1 capable of improving the durability than before and making the amount of fuel injected uniform as compared with the conventional case.

Although the embodiments of the present invention have been described in detail with reference to the drawings, the specific configuration is not limited to these embodiments, and even if design changes and the like are made without departing from the gist of the present invention, they are included in the present invention.

The present invention is not limited to the embodiments described above, but includes various modifications. For example, the above-described embodiments have been described in detail for easy understanding of the present invention, and the present invention is not necessarily limited to embodiments having all the configurations described.

### REFERENCE SIGNS LIST

1 fuel injection valve
10 nozzle body
11 injection hole
12 front end member
121 inner peripheral face of recess
122 recess
123 cutout
124 seat face
125 receiving recess
13 small diameter portion of nozzle body
130 internal space of small diameter portion
131 groove
14 large diameter portion of nozzle body
140 internal space of large diameter portion
141 recess
15 sealing member
16 inner peripheral face of nozzle body
20 valve body 21 rear end
211 rear end side sliding portion
211c center of rear end side sliding portion
212 flow path forming portion
212a flat face
213 engaging portion
214 projection
22 intermediate portion
221 outer peripheral face of intermediate portion
222 insertion portion
223 neck
23 front end
230 spherical portion
231 front end side sliding portion
232 seat portion
233 projection
30 movable core
31 valve body insertion hole (through hole)
32 eccentric through hole
40 fixed core
41 inner peripheral face
42 through hole
43 opening
44 enlarged diameter portion
50 coil
51 coil bobbin
61 coil spring
62 adjustment member
63 small coil spring
70 housing
71 bottom through hole
80 resin portion
81 connector
811 terminal
90 filter
A central axis of nozzle body
A′ central axis of valve body
AR1 angle range of portion where rear end side sliding portion is formed
AR2 angle range of portion where flow path forming portion is formed
AS angular intervals of center of rear end side sliding portion
Da axial direction FC fuel flow path
G1 gap between outer peripheral face of intermediate portion of valve body and inner peripheral face of nozzle body
G2 gap between coil spring and inner peripheral face of fixed core
G3 gap between side face of movable core and inner peripheral face of nozzle body
IA included angle between flat faces of flow path forming portion

1. A fuel injection valve comprising:
a nozzle body having an injection hole;
a valve body having a front end that opens and closes the injection hole;
a movable core that has a through hole in which the valve body is slidably inserted, and that is engaged with a rear end of the valve body to move together with the valve body; and
a fixed core that attracts the movable core by a magnetic attraction force,
wherein
the front end of the valve body has a spherical portion that slides on an inner peripheral face of the nozzle body, and an intermediate portion between the front end and the rear end of the valve body has an insertion portion that is inserted into the through hole to slide on the through hole, and a neck located downstream of the insertion portion and upstream of the spherical portion, and
φB>φC>φD>φE>φF is satisfied where φB represents a hole diameter of the through hole formed in the movable core, QC represents an outer diameter of the insertion portion at the intermediate portion, of the valve body, that slides on the through hole, φD represents a diameter of the inner peripheral face, of the nozzle body, that slides on the spherical portion of the valve body, φE represents an outermost diameter of the spherical portion of the valve body, and φF represents an outer diameter of the neck at the intermediate portion of the valve body, and a side face of the movable core and the inner peripheral face of the nozzle body are not in contact with each other.

2. A fuel injection valve comprising:
a nozzle body having an injection hole;
a valve body having a front end that opens and closes the injection hole;
a movable core that is engaged with a rear end of the valve body to move together with the valve body; and
a fixed core that attracts the movable core by a magnetic attraction force,
wherein
the valve body is composed of one member from the rear end to the front end, and the front end of the valve body has a spherical portion in which a sliding portion that slides on an inner peripheral face of the nozzle body and a seat portion that contacts a seat face of a front end of the nozzle body are formed of a same spherical face.

3. A fuel injection valve comprising:
a nozzle body having an injection hole;
a valve body having a front end that opens and closes the injection hole;
a movable core that is engaged with a rear end of the valve body to move together with the valve body; and
a tubular fixed core that attracts the movable core by a magnetic attraction force,
wherein
the nozzle body has a front end member that has the injection hole and that receives the front end of the valve body, and
the valve body is composed of one member from the rear end to the front end, has a rear end side sliding portion and a front end side sliding portion at the rear end and the front end, respectively, and when the injection hole is opened and closed, the rear end side sliding portion slides in contact with an inner peripheral face of the fixed core and the front end side sliding portion slides in contact with an inner peripheral face of the front end member.

4. The fuel injection valve according to claim 1, wherein the valve body is composed of one member from the rear end to the front end.

5. The fuel injection valve according to claim 2, wherein the valve body has a neck having an outer diameter smaller than an outer diameter of the spherical portion at an upstream side relative to the spherical portion.

6. The fuel injection valve according to claim 3, wherein the valve body has a spherical portion having the front end side sliding portion.

7. The fuel injection valve according to claim 3, wherein
a plurality of the rear end side sliding portions is provided at the rear end in a circumferential direction, and a flow path forming portion is provided between the adjacent rear end side sliding portions, and
the rear end side sliding portions have a partially cylindrical outer peripheral face, and the flow path forming portion has a flat face.

8. The fuel injection valve according to claim 3, wherein
a plurality of the rear end side sliding portions is provided at the rear end in a circumferential direction, and a flow path forming portion is provided between the adjacent rear end side sliding portions, and
in the circumferential direction of the rear end, an angle range of a portion where the flow path forming portion is formed is larger than an angle range of a portion where the rear end side sliding portion is formed.

9. The fuel injection valve according to claim 7, wherein
the fixed core has an enlarged diameter portion whose inner diameter increases as the fixed core is close to the movable core, and
at least part of the flow path forming portion is disposed inside the enlarged diameter portion in a state where the injection hole is closed.

10. The fuel injection valve according to claim 3, wherein the fuel injection valve has a gap between an outer peripheral face of an intermediate portion between the rear end and the front end of the valve body and an inner peripheral face of the tubular nozzle body.

11. The fuel injection valve according to claim 3, wherein
the valve body has a spherical portion having the front end side sliding portion and has a conical projection toward a front end relative to the front end side sliding portion,
the front end member is provided at a front end of the tubular nozzle body, has a concave seat face that receives the spherical portion, and has a receiving recess that receives at least part of the projection, the receiving recess being provided toward a front end relative to the seat face, and
the seat face has a truncated cone shape whose diameter is gradually reduced toward a front end of the nozzle body in an axial direction, and the injection hole is opened.

12. The fuel injection valve according to claim 1, further comprising:
a coil spring that urges the valve body toward the injection hole,
wherein the valve body has a projection that engages with an inner side of the coil spring.

13. The fuel injection valve according to claim 1, wherein a portion, of the rear end, adjacent to the movable core and the intermediate portion have a cylindrical outer peripheral face centered on a central axis of the valve body.

14. The fuel injection valve according to claim 13, wherein an outer diameter of a portion, of the rear end of the valve body, adjacent to the movable core is larger than an outer diameter of the intermediate portion.

15. The fuel injection valve according to claim 1, wherein an outer diameter of the rear end is smaller than an inner diameter of the fixed core, and the rear end is movably provided inside the fixed core.
